(19) United States
(12) Patent Application Publication
(10) Pub. No.: US 2026/0320009 A1
(43) Pub. Date: Oct. 15, 2026

(54) SYSTEM AND METHOD FOR REAL-TIME DETECTION, ASSESSMENT, AND MITIGATION OF THE IMPACTS OF DISRUPTIONS IN COMPLEX INTERCONNECTED DATA REPOSITORIES

(71) Applicant: BANK OF AMERICA CORPORATION, Charlotte, NC (US)

(72) Inventors: Chetan Singh Naruka, Gurugram (IN); N. Tulasi Bhavani, Hyderabad (IN); Vinod Maghnani, Gurugram (IN); Kalpesh Salot, Simi Valley, CA (US)

(73) Assignee: BANK OF AMERICA CORPORATION, Charlotte, NC (US)

(21) Appl. No.: 19/178,456

(22) Filed: Apr. 14, 2025

(51) Int. Cl. G06F 16/21

(52) U.S. Cl. CPC G06F 16/213

(57) ABSTRACT

Embodiments of the present invention provide a system for real-time detection, assessment, and mitigation of the impacts of disruptions in complex interconnected data repositories. The system is configured to continuously monitor a plurality of data repositories to detect schema changes, detect a schema change associated with an data repository of the plurality of data repositories, determine impact of the schema change associated with the data repository on downstream data repositories, determine exposures associated with the schema change on one or more entity applications consuming data from the downstream data repositories, generate one or more mitigation actions to mitigate impacts of the exposures, implement the one or more mitigation actions on the downstream data repositories, and continuously monitor the one or more entity applications and the downstream data repositories based on implementing the one or more mitigation actions on the downstream data repositories.

### BACKGROUND

There exists a need for a system that can detect, assess, and mitigate the impacts of disruptions in complex interconnected data repositories.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for real-time detection, assessment, and mitigation of the impacts of disruptions in complex interconnected data repositories. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention continuously monitors a plurality of entity data repositories to detect schema changes, detects a schema change associated with an entity data repository of the plurality of entity data repositories based on continuously monitoring the plurality of entity data repositories, determines impact of the schema change associated with the entity data repository on downstream entity data repositories of the plurality of entity data repositories that are downstream to the entity data repository, determines exposures associated with the schema change on one or more entity applications consuming data from the downstream entity data repositories, generates one or more mitigation actions to mitigate impacts of the exposures associated with the schema change on the downstream entity data repositories, implements the one or more mitigation actions on the downstream entity data repositories, and continuously monitors the one or more entity applications, the entity data repository, and the downstream entity data repositories based on implementing the one or more mitigation actions on the downstream entity data repositories.

In some embodiments, the present invention detects the schema change based on identifying modifications to at least the entity repository of the plurality of entity data repositories based on continuously monitoring the plurality of data repositories, instantaneously converting data in the entity data repository comprising the modifications into real-time high-dimension vectors, comparing the real-time high-dimension vectors with previous high-dimension vectors associated with previous data in the entity data repository from a previous time-stamp, detecting a difference between the real-time high-dimension vectors and the previous high-dimension vectors, and identifying the difference between the real-time high-dimension vectors and the previous high-dimension vectors as the schema change.

In some embodiments, the present invention performs the historical data analysis to determine the exposures associated with the schema change based on generating real-time simulations via hyperdimensional computing.

In some embodiments, the present invention determines impact of the schema change associated with the entity data repository on downstream entity data repositories of the plurality of entity data repositories that are downstream to the entity data repository based on identifying interdependencies associated with the entity data repository.

In some embodiments, the present invention dynamically generates a visual representation of the impact of the schema changes on the downstream data repositories.

In some embodiments, the visual representation further comprises the identified exposures associated with the schema change.

In some embodiments, the present invention determines criticality of the identified exposures associated with the schema change and displays the criticality on the visual representation.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for real-time detection, assessment, and mitigation of the impacts of disruptions in complex interconnected data repositories, in accordance with an embodiment of the invention;

FIG. 2 provides a block diagram illustrating the entity system(s) 200 of FIG. 1, in accordance with an embodiment of the invention;

FIG. 3 provides a block diagram illustrating the disruption detection and mitigation system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for real-time detection, assessment, and mitigation of the impacts of disruptions in complex interconnected data repositories, in accordance with an embodiment of the invention; and

FIG. 6 provides a block diagram illustrating the process of real-time detection, assessment, and mitigation of the impacts of disruptions in complex interconnected data repositories, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more data repositories for storing data associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution. As described herein, a “user” may be an employee, a customer, or a potential customer of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Organizations today rely on complex ecosystems of interconnected databases, which feed critical downstream applications. When schema changes occur in upstream systems, they can cause significant disruptions across multiple systems, leading to incorrect reports, operational failures, and financial exposures. Conventional solutions are primarily reactive, focusing on isolated monitoring without addressing the complex interdependencies between systems. This creates a gap in identifying and managing exposures in real time, leaving organizations vulnerable to cascading errors and delayed responses.

Conventional systems rely on outdated methods, such as Euclidean distance and basic relational models, which cannot handle the complexity of modern, high-dimensional databases. These conventional systems detect issues only after they have caused significant disruptions, leading to inefficiencies and operational losses. Additionally, there is a lack of real-time detection for upstream schema changes, and existing tools fail to recommend tailored, actionable solutions. As a result, organizations face challenges in managing exposures and mitigating disruptions, often relying on manual interventions prone to error.

As modern ecosystems incorporate a mix of legacy systems, cloud-based platforms, and distributed architectures, maintaining visibility into these environments becomes increasingly complex, lack the flexibility to adapt to changes in data structures and technology integrations. This limits their ability to provide timely insights or predict cascading effects from schema changes, leaving organizations exposed to prolonged downtime, financial losses, and compromised decision-making. As such, there is a need for a proactive, intelligent system that identifies exposures and also provides predictive insights and automated recommendations across these dynamic interconnected systems.

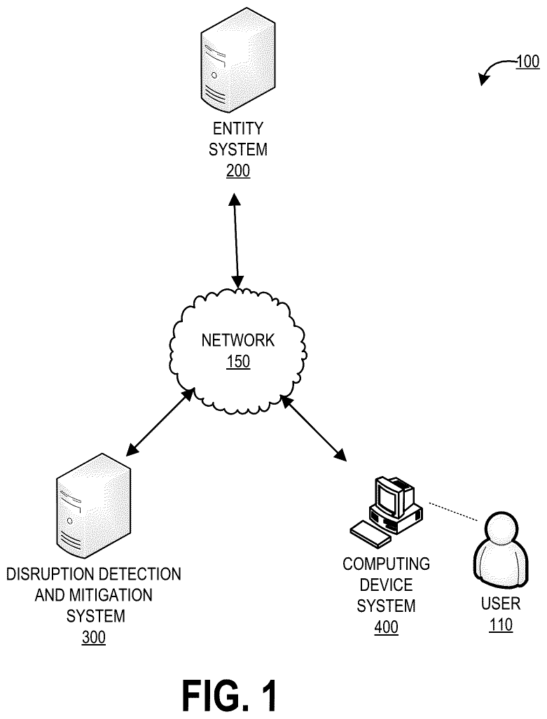

FIG. 1 provides a block diagram illustrating a system environment 100 for real-time detection, assessment, and mitigation of the impacts of disruptions in complex interconnected data repositories, in accordance with an embodiment of the invention. As illustrated in FIG. 1, the environment 100 includes a disruption detection and mitigation system 300, an entity system 200, and a computing device system 400. One or more users 110 may be included in the system environment 100, where the users 110 interact with the other entities of the system environment 100 via a user interface of the computing device system 400. In some embodiments, the one or more users 110 may be employees of the entity associated with the entity system 200.

The entity system(s) 200 may be any system owned or otherwise controlled by an entity to support or perform one or more process steps described herein. In some embodiments, the entity may be any organization that utilizes one or more data repositories for storing data associated with the entity. In some embodiments, the entity is a financial institution. In some embodiments, the entity is a non-financial institution. In some embodiments, the one or more software applications may be developed by the entity resources to perform the one or more activities. In some embodiments, the entity systems 200 may be complex interconnected data repositories or systems hosting the complex interconnected data repositories.

The disruption detection and mitigation system 300 is a system of the present invention for performing one or more process steps described herein. In some embodiments, the disruption detection and mitigation system 300 may be an independent system. In some embodiments, the disruption detection and mitigation system 300 may be a part of the entity system 200. In some embodiments, the disruption detection and mitigation system 300 may be controlled, owned, managed, and/or maintained by the entity associated with the entity system 200.

The disruption detection and mitigation system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the disruption detection and mitigation system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the disruption detection and mitigation system 300, and/or entity system 200 across the network 150.

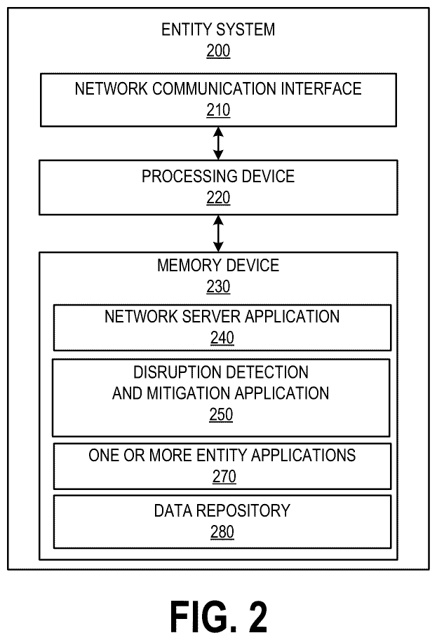

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to perform one or more processing functionalities described herein and also to operate the network communication interface 210 to perform certain communication functions of the entity system 200 described herein. For example, in one embodiment of the entity system 200, the memory device 230 includes, but is not limited to, a disruption detection and mitigation application 250, one or more entity applications 270, and a data repository 280. The one or more entity applications 270 may be any applications developed, supported, maintained, utilized, and/or controlled by the entity. The computer-executable program code of the network server application 240, the disruption detection and mitigation application 250, the one or more entity application 270 to perform certain logic, data-extraction, and data-storing functions of the entity system 200 described herein, as well as communication functions of the entity system 200.

The network server application 240, the disruption detection and mitigation application 250, and the one or more entity applications 270 are configured to store data in the data repository 280 or to use the data stored in the data repository 280 when communicating through the network communication interface 210 with the disruption detection and mitigation system 300, and/or the computing device system 400 to perform one or more process steps described herein. In some embodiments, the entity system 200 may receive instructions from the disruption detection and mitigation system 300 via the disruption detection and mitigation application 250 to perform certain operations. The disruption detection and mitigation application 250 may be provided by the disruption detection and mitigation system 300. The one or more entity applications 270 may be any of the applications used, created, modified, facilitated, developed, and/or managed by the entity system 200.

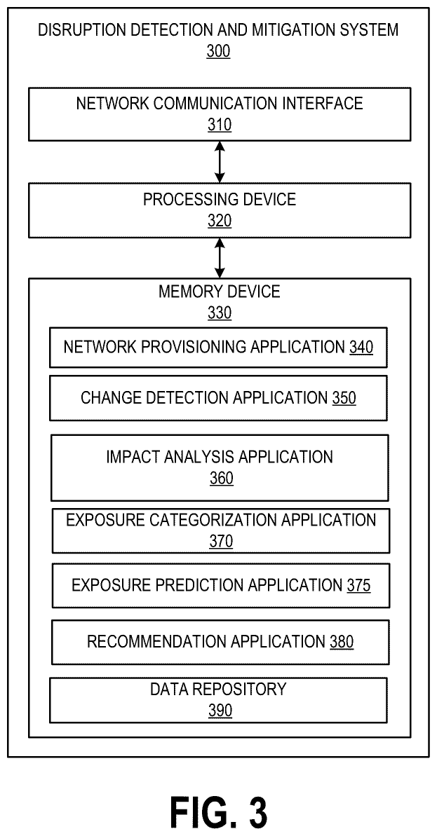

FIG. 3 provides a block diagram illustrating the disruption detection and mitigation system 300 in greater detail, in accordance with embodiments of the invention. As illustrated in FIG. 3, in one embodiment of the invention, the disruption detection and mitigation system 300 includes one or more processing devices 320 operatively coupled to a network communication interface 310 and a memory device 330. In certain embodiments, the disruption detection and mitigation system 300 is operated by an entity, such as a financial institution. In some embodiments, the disruption detection and mitigation system 300 is owned or operated by the entity of the entity system 200. In some embodiments, the disruption detection and mitigation system 300 may be an independent system. In alternate embodiments, the disruption detection and mitigation system 300 may be a part of the entity system 200.

It should be understood that the memory device 330 may include one or more databases or other data structures/repositories. The memory device 330 also includes computer-executable program code that instructs the processing device 320 to perform processing operations described herein and to operate the network communication interface 310 to perform certain communication functions of the disruption detection and mitigation system 300. For example, in one embodiment of the disruption detection and mitigation system 300, the memory device 330 includes, but is not limited to, a network provisioning application 340, a change detection application 350, an impact analysis application 360, an exposure categorization application 370, an exposure detection application 375, a recommendation application 380, and a data repository 390 comprising any data processed or accessed by one or more applications in the memory device 330. The computer-executable program code of the network provisioning application 340, the change detection application 350, the impact analysis application 360, the exposure categorization application 370, the exposure detection application 375, and the recommendation application 380 may instruct the processing device 320 to perform certain logic, data-processing, and data-storing functions of the disruption detection and mitigation system 300 described herein, as well as communication functions of the disruption detection and mitigation system 300.

The network provisioning application 340, the change detection application 350, the impact analysis application 360, the exposure categorization application 370, the exposure detection application 375, and the recommendation application 380 are configured to invoke or use the data in the data repository 390 when communicating through the network communication interface 310 with the entity system 200, and/or the computing device system 400. In some embodiments, the network provisioning application 340, the change detection application 350, the impact analysis application 360, the exposure categorization application 370, the exposure detection application 375, and the recommendation application 380 may store the data extracted or received from the entity system 200, and the computing device system 400 in the data repository 390. In some embodiments, the network provisioning application 340, the change detection application 350, the impact analysis application 360, the exposure categorization application 370, the exposure detection application 375, and the recommendation application 380 may be a part of a single application (e.g., modules).

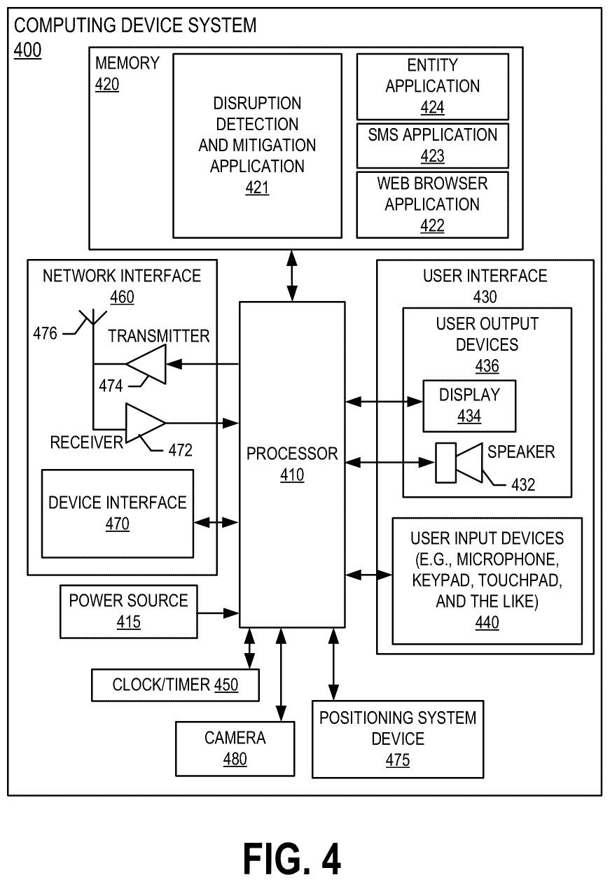

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a disruption detection and mitigation application 421, entity application 424. These applications also typically instructions to a graphical user interface (GUI) on the display 430 that allows the user 110 to interact with the entity system 200, the disruption detection and mitigation system 300, and/or other devices or systems. The memory 420 of the computing device system 400 may comprise a Short Message Service (SMS) application 423 configured to send, receive, and store data, information, communications, alerts, and the like via the wireless network. In some embodiments, the disruption detection and mitigation application 421 provided by the disruption detection and mitigation system 300 allows the user 110 to access the disruption detection and mitigation system 300. In some embodiments, the entity application 424 provided by the entity system 200 and the disruption detection and mitigation application 421 allow the user 110 to access the functionalities provided by the disruption detection and mitigation system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

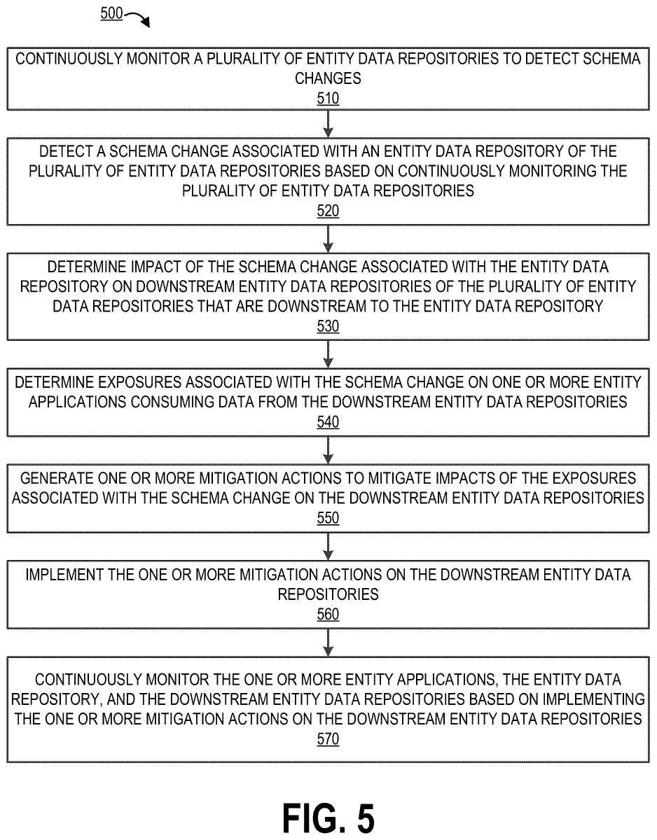

FIG. 5 provides a flowchart 500 illustrating a process flow for real-time detection, assessment, and mitigation of the impacts of disruptions in complex interconnected data repositories, in accordance with an embodiment of the invention.

As shown in block 510, the system continuously monitors a plurality of entity data repositories to detect schema changes. The plurality of entity data repositories may be any data repositories including, but not limited to, databases, data warehouses, data lakes, open data repositories, file systems, data marts, content management systems, version control systems, blockchain repositories, and/or the like. In some embodiments of the invention, the plurality of entity data repositories may refer to databases (e.g., Relational databases, NoSQL databases, graph databases, Time-Series Databases, and/or the like). Continuously monitoring the plurality of entity data repositories may comprise detecting any modifications to the plurality of entity data repositories, where the modifications may be performed by entity users (e.g., entity employees, entity customers, etc.) or by entity applications.

As shown in block 520, the system detects a schema change associated with an entity data repository of the plurality of entity data repositories based on continuously monitoring the plurality of entity data repositories. The system may detect schema change by employing hyperdimensional computing that employs hyperdimensional vectors to represent and modify data, where data is encoded into hyperdimensional vectors that have thousands or tens of thousands of dimensions. The system may detect schema changes based on identifying modifications to at least the entity repository of the plurality of entity data repositories based on continuously monitoring the plurality of data repositories, instantaneously converting data in the entity data repository comprising the modifications into real-time high-dimension vectors, comparing the real-time high-dimension vectors with previous high-dimension vectors associated with previous data in the entity data repository from a previous time-stamp, detecting a difference between the real-time high-dimension vectors and the previous high-dimension vectors, and identifying the difference between the real-time high-dimension vectors and the previous high-dimension vectors as the schema change. For example, the system may dynamically detect that a new column is added to an existing database associated with financial transactions, where the new column represents status of the financial transactions. The system may dynamically encode each of the financial transactions comprising the newly added status of each financial transaction into hyperdimensional vectors, where each hyperdimensional vector represents a financial transaction. The system then compares the hyperdimensional vectors with previously created hyperdimensional vectors for the financial transaction database at a previous timestamp to determine any differences between the two vectors. Upon determining the differences between the two vectors, the system identifies the differences as changes to schema of the financial transaction database.

As shown in block 530, the system determines impact of the schema change associated with the entity data repository on downstream entity data repositories of the plurality of entity data repositories that are downstream to the entity data repository. The system analyzes how the schema changes in a data repository can have hidden effects on other entity applications and downstream entity data repositories. The system identifies all dependencies associated with the entity data repository. In some embodiments, the system may identify the dependencies based on creating a visual representation of relations between the plurality of databases with the entity data repository that is associated with the schema change. In some embodiments, the system may access usage data or dataflow information associated with the entity data repository to determine the interdependencies of the plurality of data repositories with the entity data repositories. Continuing with the previous example, the system may identify that a new column is added to the financial transaction database and it may analyze other applications (e.g., payment processing application, exposure detection application, and/or the like) and downstream databases that are taking in data from the financial transaction database.

As shown in block 540, the system determines exposures associated with the schema change on one or more entity applications consuming data from the downstream entity data repositories. The system may further perform historical data analysis to determine the exposures associated with the schema change on one or more entity applications consuming data from the downstream entity data repositories. In some embodiments, the system may dynamically generate real-time simulations of entity systems to identify the exposures via hyperdimensional computing. In some embodiments, the system may identify patterns in the real-time simulations that are similar to historical patterns that are associated with historical exposures. Exposures may comprise disruptions or failures in functioning of the one or more entity applications. Continuing with the previous example, the system generate real-time simulations of financial systems to identify disruptions of failures in functioning of banking applications, where disruptions or failures may comprise incorrect account balance calculations, failure of misappropriation detection models, and/or the like. Based on the real-time simulations the system may assess the impact of schema changes and cascading effects the schema changes may have on one or more entity applications and downstream entity data repositories. In some embodiments, the system may further determine criticality of the identified exposures associated with the schema change based on calculating criticality scores of the identified exposures (e.g., 90% criticality). The system may determine the criticality of the identified exposure based on the type of downstream entity data repository or type of entity application that is consuming data from the entity data repository that is associated with the schema change.

As shown in block 550, the system generates one or more mitigation actions to mitigate impacts of the exposures associated with the schema change on the downstream entity data repositories. The mitigation actions may comprise making program code changes in one or more entity applications, adjusting detection thresholds in detection mechanisms, changing logics in databases, and/or the like. For example, the system may identify that addition of a field creates an issue with balance calculations in a reporting application, the system may generate a mitigation action comprising updating the application to accommodate the new field. The system may also predict likelihood of success associated with the one or more mitigation actions.

In some embodiments, the system may dynamically generate a visual representation of the impact of the schema changes on the downstream data repositories. In some embodiments, the visual representation further comprises the identified exposures associated with the schema change. In some embodiments, the system may display the calculated criticality scores associated with the identified exposures on the visual representation. In some embodiments, the system may also display the mitigation actions and success rates associated with the mitigation actions on the visual representation. In some embodiments, the system may dynamically modify the visual representations based on new schema changes that are identified in real-time and also modify the visual representations based on implementing the mitigation actions.

As shown in block 560, the system implements the one or more mitigation actions on the downstream entity data repositories. In some embodiments, the system may automatically implement the one or more mitigation actions. In some embodiments, the system may generate the mitigation steps associated with implementing the mitigation actions and display them to entity users, via a graphical user interface.

As shown in block 570, the system continuously monitors the one or more entity applications, the entity data repository, and the downstream entity data repositories based on implementing the one or more mitigation actions on the downstream entity data repositories. The system may also generate one or more alerts or notifications based on continuously monitoring the one or more entity applications, the entity data repository, and the downstream entity data repositories based on implementing the one or more mitigation actions on the downstream entity data repositories.

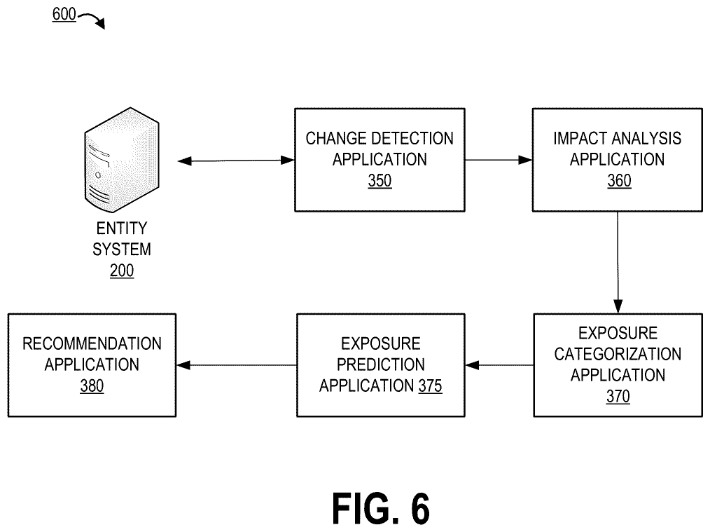

FIG. 6 provides a block diagram illustrating the process of real-time detection, assessment, and mitigation of the impacts of disruptions in complex interconnected data repositories, in accordance with an embodiment of the invention. As shown, the change detection application 350 takes inputs from one or more entity systems 200 and/or one or more data repositories associated with the one or more entity systems 200. Examples of data inputs may comprise entity databases, entity data warehouses, databanks, data lakes, historical schema change data and dependency mapping, enterprise reports historical usages, business intelligence logs, user input, and/or the like. The change detection application 350 monitors plurality of entity data repositories and detects any modifications to the plurality of entity data repositories. Based on identified modifications, the impact analysis application 360 may determine impacts of identified modifications on downstream data repositories and also identifies exposures caused by the identified modifications based on generating real-time simulations. The exposure categorization application 370 may then categorize the identified exposures and may generate criticality scores for each of the identified exposures. The exposure prediction application 375 may forecast future exposures based on the identified exposures and the modifications identified by the change detection application 350. The recommendation application 380 may generate and implement one or more mitigation actions to mitigate the impacts of identified modifications, identified exposures, and future forecasted exposures.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for real-time detection, assessment, and mitigation of the impacts of disruptions in complex interconnected data repositories, the system comprising:
at least one network communication interface;
at least one non-transitory storage device; and
at least one processing device coupled to the at least one non-transitory storage device and the at least one network communication interface, wherein the at least one processing device is configured to:
continuously monitor a plurality of entity data repositories to detect schema changes;
detect a schema change associated with an entity data repository of the plurality of entity data repositories based on:
continuously monitoring the plurality of entity data repositories;
identifying modifications to at least the entity data repository of the plurality of entity data repositories based on continuously monitoring the plurality of data repositories;
instantaneously converting data in the entity data repository comprising the modifications into real-time high-dimension vectors;
comparing the real-time high-dimension vectors with previous high-dimension vectors associated with previous data in the entity data repository from a previous time-stamp;
detecting a difference between the real-time high-dimension vectors and the previous high-dimension vectors; and
identifying the difference between the real-time high-dimension vectors and the previous high-dimension vectors as the schema change;
determine impact of the schema change associated with the entity data repository on downstream entity data repositories of the plurality of entity data repositories that are downstream to the entity data repository;
determine exposures associated with the schema change on one or more entity applications consuming data from the downstream entity data repositories;
generate one or more mitigation actions to mitigate impacts of the exposures associated with the schema change on the downstream entity data repositories;
implement the one or more mitigation actions on the downstream entity data repositories; and
continuously monitor the one or more entity applications, the entity data repository, and the downstream entity data repositories based on implementing the one or more mitigation actions on the downstream entity data repositories.

2. (canceled)

3. The system of claim 1, wherein the at least one processing device is configured to perform historical data analysis to determine the exposures associated with the schema change based on generating real-time simulations via hyperdimensional computing.

4. The system of claim 1, wherein the at least one processing device is configured to determine the impact of the schema change associated with the entity data repository on downstream entity data repositories of the plurality of entity data repositories that are downstream to the entity data repository based on identifying interdependencies associated with the entity data repository.

5. The system of claim 1, wherein the at least one processing device is configured to dynamically generate a visual representation of the impact of the schema changes on the downstream data repositories.

6. The system of claim 5, wherein the visual representation further comprises the exposures associated with the schema change.

7. The system of claim 6, wherein the at least one processing device is configured to:
determine criticality of the exposures associated with the schema change; and
display the criticality on the visual representation.

8. The system of claim 1, wherein the at least one processing device is configured to generate one or more alerts associated with effect of the one or more mitigation actions based on monitoring the one or more entity applications, the entity data repository, and the downstream entity data repositories after implementing the one or more mitigation actions on the downstream entity data repositories.

9. A computer program product for real-time detection, assessment, and mitigation of the impacts of disruptions in complex interconnected data repositories, the computer program product comprising a non-transitory computer-readable storage medium having computer executable instructions for causing a computer processor to perform the steps of:
continuously monitoring a plurality of entity data repositories to detect schema changes;
detecting a schema change associated with an entity data repository of the plurality of entity data repositories based on:
continuously monitoring the plurality of entity data repositories;
identifying modifications to at least the entity data repository of the plurality of entity data repositories based on continuously monitoring the plurality of data repositories;
instantaneously converting data in the entity data repository comprising the modifications into real-time high-dimension vectors;
comparing the real-time high-dimension vectors with previous high-dimension vectors associated with previous data in the entity data repository from a previous time-stamp;
detecting a difference between the real-time high-dimension vectors and the previous high-dimension vectors; and
identifying the difference between the real-time high-dimension vectors and the previous high-dimension vectors as the schema change;
determining impact of the schema change associated with the entity data repository on downstream entity data repositories of the plurality of entity data repositories that are downstream to the entity data repository;
determining exposures associated with the schema change on one or more entity applications consuming data from the downstream entity data repositories;
generating one or more mitigation actions to mitigate impacts of the exposures associated with the schema change on the downstream entity data repositories;
implementing the one or more mitigation actions on the downstream entity data repositories; and
continuously monitoring the one or more entity applications, the entity data repository, and the downstream entity data repositories based on implementing the one or more mitigation actions on the downstream entity data repositories.

10. (canceled)

11. The computer program product of claim 9, wherein the computer executable instructions for causing the computer processor to perform the step of generating one or more alerts associated with effect of the one or more mitigation actions based on monitoring the one or more entity applications, the entity data repository, and the downstream entity data repositories after implementing the one or more mitigation actions on the downstream entity data repositories.

12. The computer program product of claim 9, wherein the computer executable instructions for causing the computer processor to perform the step of performing historical data analysis to determine the exposures associated with the schema change based on generating real-time simulations via hyperdimensional computing.

13. The computer program product of claim 9, wherein the computer executable instructions for causing the computer processor to perform the step of determining the impact of the schema change associated with the entity data repository on downstream entity data repositories of the plurality of entity data repositories that are downstream to the entity data repository based on identifying interdependencies associated with the entity data repository.

14. The computer program product of claim 9, wherein the computer executable instructions for causing the computer processor to perform the step of dynamically generating a visual representation of the impact of the schema changes on the downstream data repositories.

15. The computer program product of claim 14, wherein the visual representation further comprises the exposures associated with the schema change.

16. A computer implemented method for real-time detection, assessment, and mitigation of the impacts of disruptions in complex interconnected data repositories, wherein the method comprises:
continuously monitoring a plurality of entity data repositories to detect schema changes;
detecting a schema change associated with an entity data repository of the plurality of entity data repositories based on:
continuously monitoring the plurality of entity data repositories;
identifying modifications to at least the entity data repository of the plurality of entity data repositories based on continuously monitoring the plurality of data repositories;
instantaneously converting data in the entity data repository comprising the modifications into real-time high-dimension vectors;
comparing the real-time high-dimension vectors with previous high-dimension vectors associated with previous data in the entity data repository from a previous time-stamp;
detecting a difference between the real-time high-dimension vectors and the previous high-dimension vectors; and
identifying the difference between the real-time high-dimension vectors and the previous high-dimension vectors as the schema change;
determining impact of the schema change associated with the entity data repository on downstream entity data repositories of the plurality of entity data repositories that are downstream to the entity data repository;
determining exposures associated with the schema change on one or more entity applications consuming data from the downstream entity data repositories;
generating one or more mitigation actions to mitigate impacts of the exposures associated with the schema change on the downstream entity data repositories;
implementing the one or more mitigation actions on the downstream entity data repositories; and
continuously monitoring the one or more entity applications, the entity data repository, and the downstream entity data repositories based on implementing the one or more mitigation actions on the downstream entity data repositories.

17. (canceled)

18. The computer implemented method of claim 16, wherein the method comprises perform historical data analysis to determine the exposures associated with the schema change based on generating real-time simulations via hyperdimensional computing.

19. The computer implemented method of claim 16, wherein the method comprises dynamically generating a visual representation of the impact of the schema changes on the downstream data repositories.

20. The computer implemented method of claim 19, wherein the visual representation further comprises the exposures associated with the schema change.

21. The computer implemented method of claim 16, wherein determining impact of the schema change associated with the entity data repository on downstream entity data repositories of the plurality of entity data repositories that are downstream to the entity data repository is based on identifying interdependencies associated with the entity data repository.

22. The computer implemented method of claim 16, wherein the method further comprises predicting likelihood of success associated with the one or more mitigation actions.

23. The system of claim 1, wherein the at least one processing device is configured to predict likelihood of success associated with the one or more mitigation actions.
